(19) United States
(12) Patent Application Publication
(10) Pub. No.: US 2024/0112568 A1
(43) Pub. Date: Apr. 4, 2024

(54) Vehicular Emergency Detection System, Method, and Computer Program Product

(71) Applicant: FORD GLOBAL TECHNOLOGIES, LLC, Dearborn, MI (US)

(72) Inventor: Danson Evan Lu Garcia, Pittsburgh, PA (US)

(21) Appl. No.: 17/957,546

(22) Filed: Sep. 30, 2022

(51) Int. Cl. G08G 1/01; B60W 60/00; G06K 9/62; G06V 10/80; G06V 20/58; G08G 1/16

(52) U.S. Cl. CPC G08G 1/0112; B60W 60/0015; G06K 9/6256; G06V 10/803; G06V 20/58; G08G 1/164; B60W 2556/45

(57) ABSTRACT

Disclosed herein are methods, systems, and computer program products for detecting an emergency that include: scanning, with a sensor, an environment of an autonomous vehicle on which the sensor is connected to collect environment data; analyzing the environment data using a machine learning model trained using historical data to recognize emergency situations, where the analyzing includes identifying at least a portion of the environment data as corresponding to a first emergency situation; in response to identifying the first emergency situation, generating a data packet including the environment data corresponding to the first emergency situation; and transmitting the data packet to a report center.

### BACKGROUND

### 1. Field

This disclosure relates generally to emergency situation detection and, in some non-limiting embodiments or aspects, methods, systems, and computer program products for automatically detecting an emergency situation.

### 2. Technical Considerations

Currently, audio or visual evidence corresponding to an emergency situation may be collected by civilian installed, fixed security cameras or audiovisual evidence collected by a passerby's smart phone. In the case of fixed security cameras, blindspots often restrict the utility of the collected data, such that the emergency situation must serendipitously occur within the fixed range of the security camera. In the case of audiovisual evidence collected by a passerby's smart phone, such evidence is not always available because the presence and affirmative actions of a passerby to collect the data are required. Enhanced systems for detecting emergency situations and collecting data therefor are desired.

### SUMMARY

According to some non-limiting embodiments or aspects, provided is a computer-implemented method including: scanning, with at least one sensor, an environment of an autonomous vehicle on which the at least one sensor is connected to collect environment data; analyzing, with at least one processor, the environment data using a machine learning model, wherein the machine learning model has been trained using historical data to recognize a plurality of emergency situations, where the analyzing includes identifying at least a portion of the environment data as corresponding to a first emergency situation of a plurality of emergency situations; in response to identifying the first emergency situation, generating a data packet including the environment data corresponding to the first emergency situation; and transmitting the data packet to a report center to report the first emergency situation.

According to some non-limiting embodiments or aspects, provided is a computer program product for reporting an emergency situation, the computer program product including at least one non-transitory computer-readable medium including one or more instructions that, when executed by at least one processor, cause the at least one processor to: receive environment data collected by at least one scanning an environment of an autonomous vehicle on which the at least one sensor is connected; analyze the environment data using a machine learning model, where the machine learning model has been trained using historical data to recognize a plurality of emergency situations, where the analyzing includes identifying at least a portion of the environment data as corresponding to a first emergency situation of a plurality of emergency situations; in response to identifying the first emergency situation, generate a data packet including the environment data corresponding to the first emergency situation; and transmit the data packet to a report center to report the first emergency situation.

According to some non-limiting embodiments or aspects, provided is a system including at least one sensor configured to be connected on an autonomous vehicle and configured to scan an environment of the vehicle to collect environment data; and at least one processor programmed or configured to: receive the environment data collected by the at least scanning the environment of the vehicle; analyze the environment data using a machine learning model, where the machine learning model has been trained using historical data to recognize a plurality of emergency situations, where the analyzing includes identifying at least a portion of the environment data as corresponding to a first emergency situation of a plurality of emergency situations; in response to identifying the first emergency situation, generate a data packet including the environment data corresponding to the first emergency situation; and transmit the data packet to a report center to report the first emergency situation.

### BRIEF DESCRIPTION OF THE DRAWINGS

Additional advantages and details are explained in greater detail below with reference to the exemplary embodiments that are illustrated in the accompanying schematic figures, in which:

FIG. 1 is a schematic drawing of an exemplary autonomous vehicle system according to non-limiting embodiments or aspects;

FIG. 2 is a schematic drawing illustrating exemplary system architecture for an autonomous or semi-autonomous vehicle according to non-limiting embodiments or aspects;

FIG. 3 is an illustration of a illustrative architecture for a LiDAR system according to non-limiting embodiments or aspects;

FIG. 4 is an illustration of an emergency detection system according to non-limiting embodiments or aspects;

FIG. 5 is an illustration of an emergency detection system according to non-limiting embodiments or aspects;

FIG. 6 is an illustration of an emergency detection system according to non-limiting embodiments or aspects;

FIG. 7 is a step diagram of a computer-implemented method for automatically detecting an emergency situation according to non-limiting embodiments or aspects;

FIG. 8 is a process flow diagram for a method of starting an autonomous vehicle system according to non-limiting embodiments or aspects;

FIG. 9 is a process flow diagram for a method of executing detecting and capture tasks of an emergency situation module according to non-limiting embodiments or aspects;

FIGS. 10a-10c are process flow diagrams for a method of automatically detecting an emergency situation using a direct reporting task according to non-limiting embodiments or aspects;

FIGS. 11a-11b are process flow diagrams for a method of automatically detecting an emergency situation using an indirect reporting task according to non-limiting embodiments or aspects;

FIGS. 12a-12b are process flow diagrams for a method of automatically detecting an emergency situation using an indirect reporting task according to non-limiting embodiments or aspects;

FIG. 13 is an illustration of metadata according to non-limiting embodiments or aspects;

FIG. 14 is an illustration of a classification scheme according to non-limiting embodiments or aspects; and

FIG. 15 is a schematic drawing of components of a computer system that can be used with an autonomous or semi-autonomous vehicle according to non-limiting embodiments or aspects.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

Notably, the present solution is being described herein in the context of an autonomous vehicle. However, the present solution is not limited to autonomous vehicle applications. The present solution may be used in other applications such as robotic applications, radar system applications, metric applications, and/or system performance applications.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the term “server” and/or “processor” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “user interface” or “graphical user interface” may refer to a generated display, such as one or more graphical user interfaces (GUIs) with which a user may interact, either directly or indirectly (e.g., through a keyboard, mouse, touchscreen, etc.).

Non-limiting embodiments or aspects are directed to computer-implemented methods, systems, and vehicles for automatically detecting an emergency situation. Non-limiting embodiments or aspects train a machine learning model to recognize a plurality of different emergency situations. Sensors mounted on (or connected to) autonomous vehicles may collect environment data, such as audio and/or visual data of the surroundings of the vehicle, and the environment data may be input to the machine learning model to automatically detect the presence of an emergency situation in the environment of the vehicle. Such systems enable efficient detection and identification of emergency situations utilizing hardware mounted on vehicles in the area of the emergency situation. Non-limiting embodiments or aspects also generate a data packet in response to identifying an emergency situation, which data packet comprises environment data corresponding to the detected emergency situation. The data packet may be automatically generated and transmitted to a report center to report the emergency situation, in order to automatically notify the relevant emergency responders to the situation requiring emergency intervention. In this way, non-limiting embodiments or aspects of the invention leverage sensors mounted on moving vehicles to automatically detect, identify, and report emergency situations.

According to some non-limiting embodiments or aspects, a computer-implemented method includes: scanning, with at least one sensor, an environment of a vehicle on which the at least one sensor is connected to collect environment data; analyzing, with at least one processor, the environment data using a machine learning model, wherein the machine learning model has been trained using historical data to recognize a plurality of emergency situations, wherein the analyzing comprises identifying at least a portion of the environment data as corresponding to a first emergency situation of a plurality of emergency situations; in response to identifying the first emergency situation, generating, with at least one processor, a data packet comprising the environment data corresponding to the first emergency situation; and transmitting, with at least one processor, the data packet to a report center to report the first emergency situation.

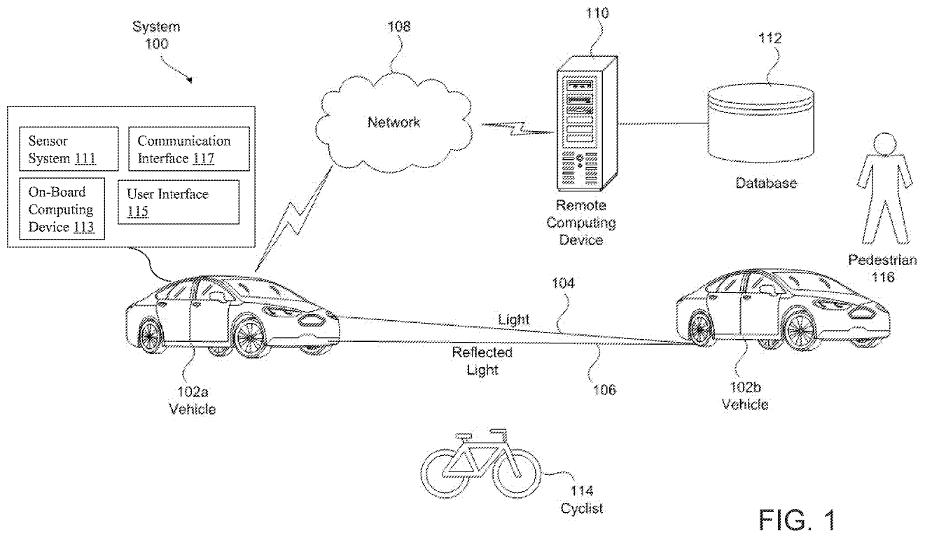

FIG. 1 illustrates an exemplary autonomous vehicle system 100, in accordance with aspects of the disclosure. System 100 comprises a vehicle 102a that is traveling along a road in a semi-autonomous or autonomous manner. Vehicle 102a is also referred to herein as AV 102a. AV 102a can include, but is not limited to, a land vehicle (as shown in FIG. 1), an aircraft, or a watercraft.

AV 102a is generally configured to detect objects 102b, 114, 116 in proximity thereto. The objects can include, but are not limited to, a vehicle 102b, cyclist 114 (such as a rider of a bicycle, electric scooter, motorcycle, or the like) and/or a pedestrian 116.

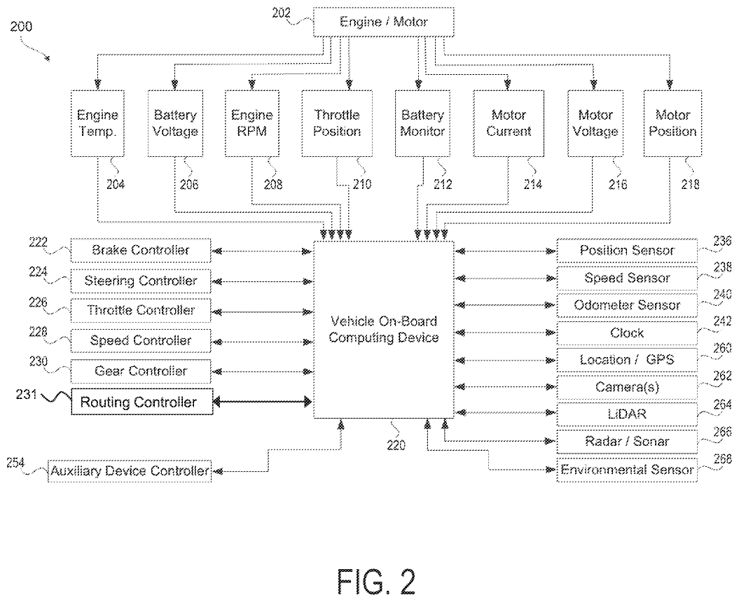

As illustrated in FIG. 1, the AV 102a may include a sensor system 111, an on-board computing device 113, a communications interface 117, and a user interface 115. Autonomous vehicle 101 may further include certain components (as illustrated, for example, in FIG. 2) included in vehicles, which may be controlled by the on-board computing device 113 using a variety of communication signals and/or commands, such as, for example, acceleration signals or commands, deceleration signals or commands, steering signals or commands, braking signals or commands, etc.

The sensor system 111 may include one or more sensors that are coupled to and/or are included within the AV 102a, as illustrated in FIG. 2. For example, such sensors may include, without limitation, a light detection and ranging (LiDAR) system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the AV 102a, information about the environment itself, information about the motion of the AV 102a, information about a route of the vehicle, or the like. As AV 102a travels over a surface, at least some of the sensors may collect data pertaining to the surface.

As will be described in greater detail, AV 102a may be configured with a LiDAR system, e.g., LiDAR system 264 of FIG. 2. The LiDAR system may be configured to transmit a light pulse 104 to detect objects located within a distance or range of distances of AV 102a. Light pulse 104 may be incident on one or more objects (e.g., AV 102b) and be reflected back to the LiDAR system. Reflected light pulse 106 incident on the LiDAR system may be processed to determine a distance of that object to AV 102a. The reflected light pulse may be detected using, in some embodiments, a photodetector or array of photodetectors positioned and configured to receive the light reflected back into the LiDAR system. LiDAR information, such as detected object data, is communicated from the LiDAR system to an on-board computing device, e.g., on-board computing device 220 of FIG. 2. The AV 102a may also communicate LiDAR data to a remote computing device 110 (e.g., cloud processing system) over communications network 108. Remote computing device 110 may be configured with one or more servers to process one or more processes of the technology described herein. Remote computing device 110 may also be configured to communicate data/instructions to/from AV 102a over network 108, to/from server(s) and/or database(s) 112.

It should be noted that the LiDAR systems for collecting data pertaining to the surface may be included in systems other than the AV 102a such as, without limitation, other vehicles (autonomous or driven), robots, satellites, etc.

Network 108 may include one or more wired or wireless networks. For example, the network 108 may include a cellular network (e.g., a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

AV 102a may retrieve, receive, display, and edit information generated from a local application or delivered via network 108 from database 112. Database 112 may be configured to store and supply raw data, indexed data, structured data, map data, program instructions or other configurations as is known.

The communications interface 117 may be configured to allow communication between AV 102a and external systems, such as, for example, external devices, sensors, other vehicles, servers, data stores, databases etc. The communications interface 117 may utilize any now or hereafter known protocols, protection schemes, encodings, formats, packaging, etc. such as, without limitation, Wi-Fi, an infrared link, Bluetooth, etc. The user interface system 115 may be part of peripheral devices implemented within the AV 102a including, for example, a keyboard, a touch screen display device, a microphone, and a speaker, etc.

FIG. 2 illustrates an exemplary system architecture 200 for a vehicle, in accordance with aspects of the disclosure. Vehicles 102a and/or 102b of FIG. 1 can have the same or similar system architecture as that shown in FIG. 2. Thus, the following discussion of system architecture 200 is sufficient for understanding vehicle(s) 102a, 102b of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 2, system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations Per Minute (“RPM”) sensor 208, and a throttle position sensor 210. If the vehicle is an electric or hybrid vehicle, then the vehicle may have an electric motor, and accordingly includes sensors such as a battery monitoring system 212 (to measure current, voltage and/or temperature of the battery), motor current 214 and voltage 216 sensors, and motor position sensors 218 such as resolvers and encoders.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device, it may be a separate device, or multiple clocks may be available.

The vehicle also includes various sensors that operate to gather information about the environment in which the vehicle is traveling. These sensors may include, for example: a location sensor 260 (e.g., a Global Positioning System (“GPS”) device); object detection sensors such as one or more cameras 262; a LiDAR system 264; and/or a radar and/or a sonar system 266. The sensors also may include environmental sensors 268 such as a precipitation sensor and/or ambient temperature sensor. The object detection sensors may enable the vehicle to detect objects that are within a given distance range of the vehicle 200 in any direction, while the environmental sensors collect data about environmental conditions within the vehicle's area of travel.

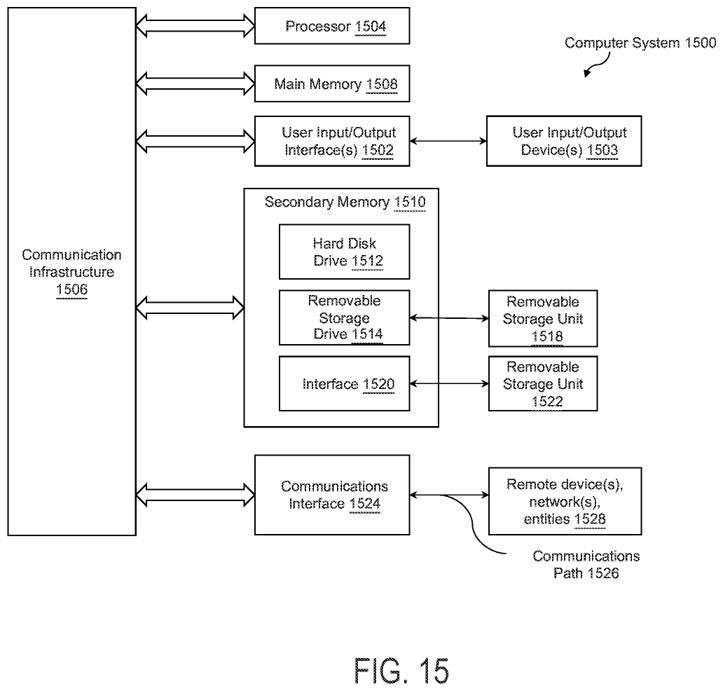

During operations, information is communicated from the sensors to a vehicle on-board computing device 220. The on-board computing device 220 may be implemented using the computer system of FIG. 15. The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as LiDAR system 264 is communicated from those sensors) to the on-board computing device 220. The object detection information and/or captured images are processed by the on-board computing device 220 to detect objects in proximity to the vehicle 200. Any known or to be known technique for making an object detection based on sensor data and/or captured images can be used in the embodiments disclosed in this document.

LiDAR information is communicated from LiDAR system 264 to the on-board computing device 220. Additionally, captured images are communicated from the camera(s) 262 to the vehicle on-board computing device 220. The LiDAR information and/or captured images are processed by the vehicle on-board computing device 220 to detect objects in proximity to the vehicle 200. The manner in which the object detections are made by the vehicle on-board computing device 220 includes such capabilities detailed in this disclosure.

The on-board computing device 220 may include and/or may be in communication with a routing controller 231 that generates a navigation route from a start position to a destination position for an autonomous vehicle. The routing controller 231 may access a map data store to identify possible routes and road segments that a vehicle can travel on to get from the start position to the destination position. The routing controller 231 may score the possible routes and identify a preferred route to reach the destination. For example, the routing controller 231 may generate a navigation route that minimizes Euclidean distance traveled or other cost function during the route, and may further access the traffic information and/or estimates that can affect an amount of time it will take to travel on a particular route. Depending on implementation, the routing controller 231 may generate one or more routes using various routing methods, such as Dijkstra's algorithm, Bellman-Ford algorithm, or other algorithms. The routing controller 231 may also use the traffic information to generate a navigation route that reflects expected conditions of the route (e.g., current day of the week or current time of day, etc.), such that a route generated for travel during rush-hour may differ from a route generated for travel late at night. The routing controller 231 may also generate more than one navigation route to a destination and send more than one of these navigation routes to a user for selection by the user from among various possible routes.

In various embodiments, the on-board computing device 220 may determine perception information of the surrounding environment of the AV 102a. Based on the sensor data provided by one or more sensors and location information that is obtained, the on-board computing device 220 may determine perception information of the surrounding environment of the AV 102a. The perception information may represent what an ordinary driver would perceive in the surrounding environment of a vehicle. The perception data may include information relating to one or more objects in the environment of the AV 102a. For example, the on-board computing device 220 may process sensor data (e.g., LiDAR or RADAR data, camera images, etc.) in order to identify objects and/or features in the environment of AV 102a. The objects may include traffic signals, road way boundaries, other vehicles, pedestrians, and/or obstacles, etc. The on-board computing device 220 may use any now or hereafter known object recognition algorithms, video tracking algorithms, and computer vision algorithms (e.g., track objects frame-to-frame iteratively over a number of time periods) to determine the perception.

In some embodiments, the on-board computing device 220 may also determine, for one or more identified objects in the environment, the current state of the object. The state information may include, without limitation, for each object: current location; current speed and/or acceleration; current heading; current pose; current shape, size, or footprint; type (e.g., vehicle vs. pedestrian vs. bicycle vs. static object or obstacle); and/or other state information.

The on-board computing device 220 may perform one or more prediction and/or forecasting operations. For example, the on-board computing device 220 may predict future locations, trajectories, and/or actions of one or more objects. For example, the on-board computing device 220 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the AV 102a, the surrounding environment, and/or their relationship(s). For example, if an object is a vehicle and the current driving environment includes an intersection, the on-board computing device 220 may predict whether the object will likely move straight forward or make a turn. If the perception data indicates that the intersection has no traffic light, the on-board computing device 220 may also predict whether the vehicle may have to fully stop prior to entering the intersection.

In various embodiments, the on-board computing device 220 may determine a motion plan for the autonomous vehicle. For example, the on-board computing device 220 may determine a motion plan for the autonomous vehicle based on the perception data and/or the prediction data. Specifically, given predictions about the future locations of proximate objects and other perception data, the on-board computing device 220 can determine a motion plan for the AV 102a that best navigates the autonomous vehicle relative to the objects at their future locations.

In some embodiments, the on-board computing device 220 may receive predictions and make a decision regarding how to handle objects and/or actors in the environment of the AV 102a. For example, for a particular actor (e.g., a vehicle with a given speed, direction, turning angle, etc.), the on-board computing device 220 decides whether to overtake, yield, stop, and/or pass based on, for example, traffic conditions, map data, state of the autonomous vehicle, etc. Furthermore, the on-board computing device 220 also plans a path for the AV 102a to travel on a given route, as well as driving parameters (e.g., distance, speed, and/or turning angle). That is, for a given object, the on-board computing device 220 decides what to do with the object and determines how to do it. For example, for a given object, the on-board computing device 220 may decide to pass the object and may determine whether to pass on the left side or right side of the object (including motion parameters such as speed). The on-board computing device 220 may also assess the risk of a collision between a detected object and the AV 102a. If the risk exceeds an acceptable threshold, it may determine whether the collision can be avoided if the autonomous vehicle follows a defined vehicle trajectory and/or implements one or more dynamically generated emergency maneuvers performed in a pre-defined time period (e.g., N milliseconds). If the collision can be avoided, then the on-board computing device 220 may execute one or more control instructions to perform a cautious maneuver (e.g., mildly slow down, accelerate, change lanes, or swerve). In contrast, if the collision cannot be avoided, then the on-board computing device 220 may execute one or more control instructions for execution of an emergency maneuver (e.g., brake and/or change direction of travel).

As discussed above, planning and control data regarding the movement of the autonomous vehicle is generated for execution. The on-board computing device 220 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

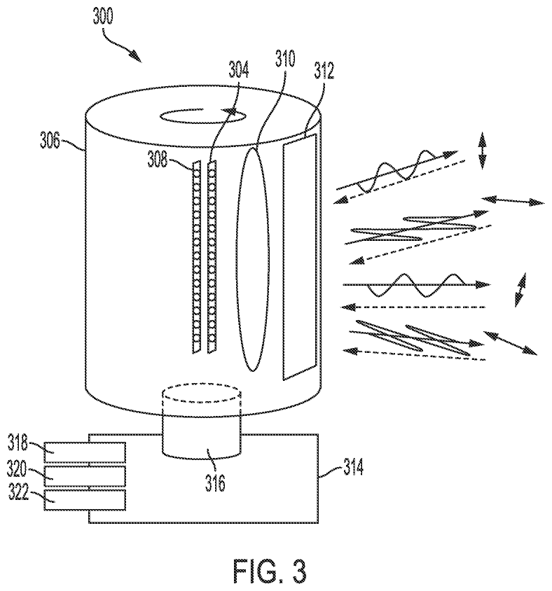

Referring now to FIG. 3, there is provided an illustration of an illustrative LiDAR system 300. LiDAR system 264 of FIG. 2 may be the same as or substantially similar to LiDAR system 300.

As shown in FIG. 3, LiDAR system 300 may include housing 306, which may be rotatable 360° about a central axis such as hub or axle 316. Housing 306 may include an emitter/receiver aperture 312 made of a material transparent to light. Although a single aperture is shown in FIG. 2, non-limiting embodiments or aspects of the present disclosure are not limited in this regard. In other scenarios, multiple apertures for emitting and/or receiving light may be provided. Either way, LiDAR system 300 can emit light through one or more of aperture(s) 312 and receive reflected light back toward one or more of aperture(s) 312 as housing 306 rotates around the internal components. In alternative scenarios, the outer shell of housing 306 may be a stationary dome, at least partially made of a material that is transparent to light, with rotatable components inside of housing 306.

Inside the rotating shell or stationary dome is a light emitter system 304 that is configured and positioned to generate and emit pulses of light through aperture 312 or through the transparent dome of housing 306 via one or more laser emitter chips or other light emitting devices. Emitter system 304 may include any number of individual emitters (e.g., 8 emitters, 64 emitters, 128 emitters, etc.). The emitters may emit light of substantially the same intensity or of varying intensities. The individual beams emitted by light emitter system 304 may have a well-defined state of polarization that is not the same across the entire array. As an example, some beams may have vertical polarization and other beams may have horizontal polarization. LiDAR system 300 may include light detector 308 containing a photodetector or array of photodetectors positioned and configured to receive light reflected back into the system. Emitter system 304 and light detector 308 may rotate with the rotating shell, or emitter system 304 and light detector 308 may rotate inside the stationary dome of housing 306. One or more optical element structures 310 may be positioned in front of light emitting system 304 and/or light detector 308 to serve as one or more lenses and/or waveplates that focus and direct light that is passed through optical element structure 310.

One or more optical element structures 310 may be positioned in front of mirror (not shown) to focus and direct light that is passed through optical element structure 310. As shown below, the system includes optical element structure 310 positioned in front of the mirror and connected to the rotating elements of the system so that optical element structure 310 rotates with mirror. Alternatively or in addition, optical element structure 310 may include multiple such structures (for example lenses and/or waveplates). Optionally, multiple optical element structures 310 may be arranged in an array on or integral with the shell portion of the housing 306.

In some non-limiting embodiments or aspects, each optical element structure 310 may include a beam splitter that separates light that the system receives from light that the system generates. The beam splitter may include, for example, a quarter-wave or half-wave waveplate to perform the separation and ensure that received light is directed to the receiver unit rather than to the emitter system (which could occur without such a waveplate as the emitted light and received light should exhibit the same or similar polarizations).

LiDAR system 300 may include power unit 318 to power the light emitting system 304, motor 316, and electronic components. LiDAR system 300 may include an analyzer 314 with elements such as processor 322 and non-transitory computer-readable memory 320 containing programming instructions that are configured to enable the system to receive data collected by the light detector unit, analyze the data to measure characteristics of the light received, and generate information that a connected system can use to make decisions about operating in an environment from which the data was collected. Analyzer 314 may be integral with the LiDAR system 300 as shown, or some or all of analyzer 314 may be external to LiDAR system 300 and communicatively connected to LiDAR system 300 via a wired and/or wireless communication network or link.

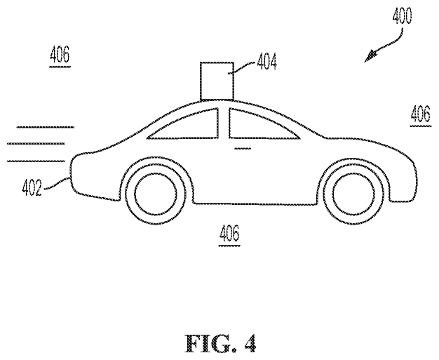

Referring to FIG. 4, an emergency detection system 400 is shown according to some non-limiting embodiments or aspects. The emergency detection system 400 may include a vehicle 402, such as an autonomous vehicle. The vehicle 402 may be a moving vehicle or a stationary vehicle. The vehicle 402 may have at least one sensor 404 mounted thereon. While FIG. 4 shows the sensor 404 mounted to the top of the vehicle 402, it will be appreciated that the sensor 404 may be mounted to any area on the vehicle 402. The sensor 404 may be a single sensor or a plurality of sensors 404. The sensor 404 may scan an environment 406 of the vehicle 402 to collect environment data. The environment 406 refers to the area surrounding the vehicle 402, including the area immediately surrounding the vehicle 402 and within detection range of the sensor 404.

The sensor 404 may be an audio sensor and/or a visual sensor. The audio sensor may detect sound, and the visual sensor may detect images surrounding the vehicle 402. Non-limiting examples of audio sensors include microphones and/or arrays of microphones. The audio sensors may be mounted on the vehicle 402 in an arrangement so as to be able to detect sound in the environment 406 of the vehicle 402. Non-limiting examples of visual sensors include any image capturing device, including, but not limited to, still cameras, video cameras, and LiDAR. The visual sensors may be mounted on the vehicle 402 in an arrangement so as to be able to detect images in the environment 406 of the vehicle 402. The audio sensor and video sensor may be the same sensor (an audiovisual sensor). It will be appreciated that other types of sensors capable of sensing sound or images may be mounted to the vehicle 402. The sensor 404 may include sensors other than audio or visual sensors. For example, the sensor may comprise a temperature sensor, pressure sensor, force sensor, vibration sensor, piezo sensor, fluid sensor, gas sensor, humidity sensor, light sensor, among many other types of sensors.

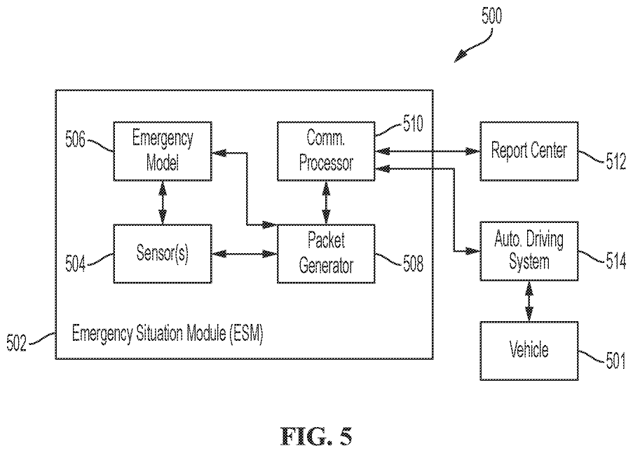

Referring to FIG. 5, an emergency detection system 500 is shown according to some non-limiting embodiments or aspects. The emergency detection system 500 may comprise an emergency situation module (ESM) 502 configured to automatically detect an emergency situation in the environment of a vehicle 501, e.g., the vehicle 402 of FIG. 4. The ESM 502 may comprise at least one sensor 504, such as any of the sensors described in connection with the sensors 404 from FIG. 4. The sensor 504 may be mounted to the vehicle 501. The sensor 504 may comprise an audio and/or visual sensor and scan the environment of the vehicle 501 to which it is mounted, in order to collect environment data. This environment data may comprise audio data and/or visual (e.g., still or moving images) data.

The ESM 502 may comprise an emergency model 506. The emergency model 506 may be a machine learning model trained to detect and identify emergency situations from audio and/or visual data. For example, the emergency model 506 may be trained to detect and identify emergency situations using historical data corresponding to historical emergency situations. The emergency model 506 may be trained to detect and identify a plurality of different types of emergency situations. The types of emergency situations identifiable by the emergency model 506 is not particularly limited and may include, for example, natural disasters (e.g., tornados or severe storms, floods, wildfires, earthquakes, etc.), man-made disasters (man-made fires, transportation accidents, industrial accidents, etc.), crime or violent activity (e.g., shootings, carjacking, looting, rioting, altercations, abductions, etc.), medical incidents (e.g., fainting, seizures, trauma, etc.), or other types of situations commonly involving intervention by emergency personnel.

Training the emergency model 506 may include inputting a training data set to the emergency model 506 to train the emergency model 506 to detect and identify emergency situations from audio and/or visual data. The training data set may comprise historical data collected by vehicle sensors 504. The training data set may additionally or alternatively comprise external historical data collected by another source, as should be understood by those of ordinary skill in the art. For example, the historical data may comprise external data sets comprising audio and/or visual data corresponding to emergency situations. In some embodiments, the historical data may be based on images, videos, or sounds related to, for example, fire, smoke, explosions, gun shots, car accidents, sirens, horns, aircrafts (e.g., airplanes, helicopters, etc.), animal sounds, human sounds, or the like. It should be understood by those ordinary skill in the art that these are merely examples and that the datasets may include other information as well.

The emergency model 506 may employ any suitable machine learning algorithm. For example, the emergency model 506 may be trained using a classification-based systems, which may be used to classify emergency situations. Alternatively, or in additionally, the emergency model 506 may be trained using a decision tree. A decision tree based system may be used, such as for sensors having distinct output data, such as smoke detectors, transducers, and the like. Other techniques can be used to remove noise or unwanted data or to improve decisions. Any combination of machine learning techniques may be used. In the machine learning techniques used, time may be a variable used in the training, validation, and testing of a model. As a non-limiting example, a gunshot event captured in audio but not supported by other sensors (e.g., a video sensor) at the same timestamp may contribute to whether such scenario is determined to be an emergency situation.

In further embodiments, the emergency model 506 may be trained using a deep learning based machine learning approach, which may be further broken down into supervised, unsupervised, and semi-supervised learning. For supervised learning, any algorithm may be used that is useful for classification, for example, artificial neural network (ANNs) algorithms such as convolutional neural networks (CNN) and support vector machines (SVMs). For unsupervised learning, the emergency model 506 may be trained using a network that may perform clustering and anomaly detection since these events may occur infrequently. In some embodiments, once an anomaly is detected, the emergency model 506 may be use an automatic classification. For semi-supervised learning, the emergency model 506 may be trained using a generative adversarial networks (GANs). In this example, a small dataset can be labelled and the deep learning network can then use this sample dataset to improve its classification accuracy.

In still further embodiments, the emergency model 506 may be trained using a reinforcement learning based approach. The reinforcement learning based approach may be performed by training the emergency model 506 in instances where the emergency model 506 was unable able to classify and/or identify an emergency situation.

In still further embodiments, the emergency model 506 may be trained using an ensemble learning based approach. The ensemble technique may be useful with the multi-modal sensing nature described herein, e.g., the use of cameras, LIDAR, audio, chemical, and/or other environment sensors. In some embodiments, a plurality of these sensors may be used as inputs to detect the emergency situation. In these instances, each sensor output can have its own set of policies to extract useful information and remove noise, be it through machine learning based, decision tree, or other methods. These policies can then be inputs into another classification algorithm with a set of weights to further classify the scenario.

In still further embodiments, the emergency model 506 may be trained using a decision tree based approach. In this approach, the set of policies can be inputs into a decision tree algorithm to classify the scenario deterministically.

The emergency model 506 may be reinforced or retrained as the sensors 504 of the ESM 502 collect further data, e.g., audio and/or visual data. For example, the emergency model 506 may receive audio and/or visual data from the sensors 504 in order to detect and classify an emergency situation. The emergency model 506 may generate a confidence parameter for the emergency situation detected to indicate the confidence with which the model believes the detected emergency situation corresponds to an actual emergency situation. If the confidence parameter does not satisfy a threshold level, the audio and/or visual data may be automatically sent to the report center 512, which may evaluate said data to determine whether the emergency situation is occurring and classify it. Based on the determination and classification of the report center 512 as to whether the emergency situation was correctly detected, the emergency model 506 may be reinforced or retrained so as to more accurately detect emergency situations in the future.

The detection of emergency situations by the emergency model 506 and the re-training and/or reinforcement thereof may take into account more than audio and/or visual data, such as data collected from other sensors such as temperature sensors, pressure sensors, force sensors, vibration sensors, piezo sensors, fluid sensors, gas sensors, humidity sensors, light sensors, among many other types of sensors.

With continued reference to FIG. 5, the sensor 504 may collect environment data from the environment of the vehicle 501 and transmit the collected environment data to the emergency model 506. The emergency model 506 may analyze the environment data to identify that at least a portion of the environment data corresponds to an emergency situation. For example, the emergency model 506 may analyze still or moving images from the emergency data to detect and identify certain images therein as corresponding to one of the emergency situations for which the emergency model 506 has been trained to recognize. For example, the emergency model 506 may analyze sounds from the emergency data to detect and identify certain sounds therein as corresponding to one of the emergency situations for which the emergency model 506 has been trained to recognize.

Identifying the emergency situation may include the emergency model 506 identifying a pattern of sounds and/or images in the environment data and matching the pattern to a pattern known by the emergency model 506 as corresponding to a certain type of emergency situation. The pattern may be made known to the emergency model 606 during the training of the emergency model, as previously described.

Once the emergency model 506 has detected an emergency situation and identified the type of emergency, the emergency model may assign an emergency identifier to the emergency situation identifying the type of emergency situation. In addition to identifying the type of emergency situation, the emergency model 506 may identify a subtype of emergency situation. A subtype of emergency situation may be a more specific description of the broader category of emergency situations. Any suitable definition of types and subtypes of emergency situations may be employed. As one non-limiting example, a type of emergency situation may be a fire, whereas the subtypes of fires may be car fires, residential fires, forest fires, and the like. Moreover, multiple types of subtypes of emergency situations may occur simultaneously and may all be identified by the emergency model 506. For example, two types of emergency situations may occur simultaneously, with one being a vehicle accident in the vehicle's 501 surroundings, and the other being a fire incident with one of the collided vehicles catching on fire.

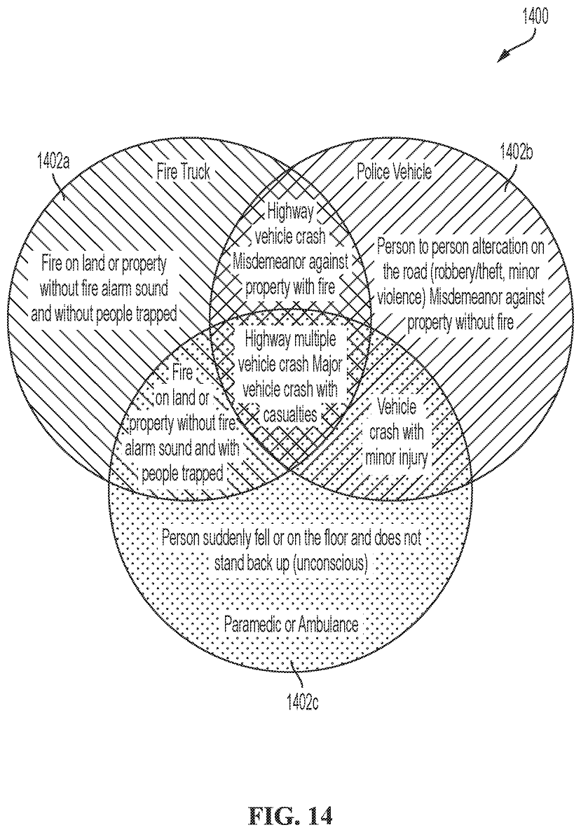

In some non-limiting embodiments or aspects, the ESM 502 may store rules associated with different types and/or subtypes of events. These rules may comprise the action to be taken by the ESM 502 based on the emergency situation identified by the emergency model 506. For example, as shown in FIG. 14, a classification scheme 1400 may identify different types or subtypes of emergency situations and correlate them to instructions as to where (which entities) to transmit the data packet. Non-limiting examples of the entities include the fire department (the computer system thereof) 1402a, the police department (the computer system thereof) 1402b, or the emergency medical services (EMS) department (the computer system thereof) 1402c. Based on the emergency situation identified by the emergency model 506, the ESM 502 may determine, based on the rules, which systems associated with the various entities should be contacted, via the communication processor 510 transmitting the data packet to the relevant system.

In response to the emergency model 506 identifying an emergency situation in the environment of the vehicle 501, a packet generator 508 may automatically generate a data packet corresponding to the emergency situation. The data packet may comprise the environment data corresponding to the emergency situation. The packet generator 508 may communicate with the emergency model 506 and the sensor 504 to collect the environment data corresponding to the emergency situation. The environment data corresponding to the emergency situation may comprise the data that caused the emergency model 506 to detect and identify the emergency situation, data collected by the sensors 504 after initial identification of the emergency situation, which may be continuing to collect data relevant to the emergency situation, and data associated with the vehicle 501 comprising the ESM. The packet generator 508 may communicate with other components of the vehicle 501 or 3 rd party components to collect data relevant to the emergency situation and/or the vehicle 501 comprising the ESM 502 which identified the emergency situation.

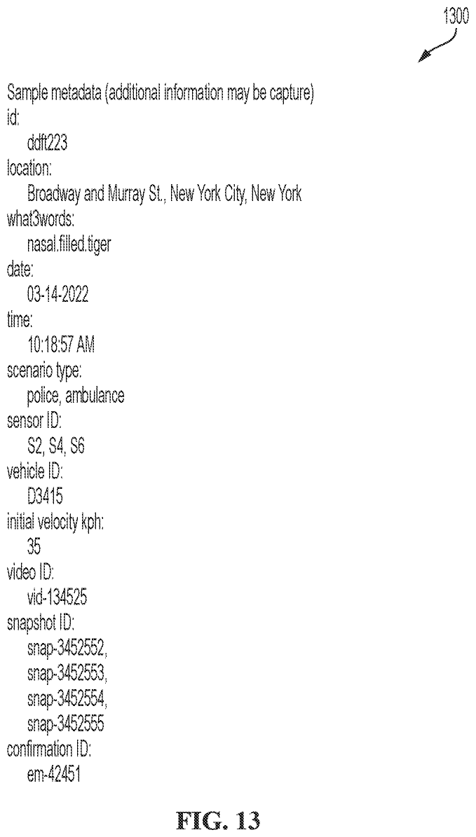

The data packet generated by the packet generator 508 may comprise the environment data corresponding (and relevant to) to the first emergency situation. The data packet may comprise data collected by the sensors 504. The data packet may comprise other data and/or metadata including, but not limited to: data and/or metadata identifiers, location data (e.g., of the vehicle 501 and/or one of the sensors 504), temporal data (e.g., a date/time stamp associated with the data), a sensor identifier (e.g., in cases of a plurality of sensors), a vehicle identifier, vehicle travel data (e.g., vehicle location, velocity, acceleration, road identifier, route information, make, model, year, color, etc.), audio and/or visual data, situation identifier data (identifying the situation identified by the emergency model 506), and the like. A non-limiting example of data/metadata 1300 that may be included in a data packet is shown in FIG. 13.

Referring again to FIG. 5, the packet generator 508 may communicate the generated data packet to a communication processor 510 of the ESM 502, which may be the processor configured to enable the ESM 502 to communicate with other systems, such as other systems of the vehicle 501, or systems external to the vehicle 501. The communication processor 510 may transmit the data packet to a report center 512.

The report center 512 may comprise a processor operated by or on behalf of a first responder system (not shown), such that the data packet may be transmitted directly to first responders equipped to respond to the emergency situation. For example, the report center 512 may be operated by or on behalf of a police department, fire department, paramedic department, or other relevant first responder and/or government agency in the area in which the emergency situation is occurring. A direct communication to the first responder system means that the ESM 502 communicates the data packet directly to the report center 512 of the first responder system, such that it is not routed through an intermediate report center (as described in other indirect embodiments hereinafter). The report center 512 in these direct reporting embodiments may comprise a secure digitized messaging system configured to receive the data packet and process the data contained therein.

In some non-limiting embodiments or aspects, the ESM 502 may report the emergency situation indirectly to the first responder system. In such embodiments, the report center 512 may comprise a processor operated by or on behalf of a control center different from the first responder system. For example, the report center 512 may be operated by or on behalf of a fleet system to which the vehicle 501 is a member, or any other third party entity. The report center 512 may process the data packet to determine whether the data contained therein should be relayed to the first responder system. In this way, the report center 512 may function as a filter such that the first responder system only receives data associated with further verified emergency situations.

The report center 512 (in the form of the fleet system) may communicate a notification regarding the emergency situation to other vehicles, such as other vehicles associated with the fleet system (“fleet vehicles”), to cause those vehicles to avoid the emergency situation. In response to receiving the report regarding the emergency situation, the report center 512 may determine a “keep out zone” which comprises a geographical area that the fleet vehicles should avoid, and data associated with the “keep out zone” may be communicated to the fleet vehicles to cause the fleet vehicles to avoid the “keep out zone.” The geographical area of the “keep out zone” may be automatically determined by the report center 512 based on data associated with the emergency situation (e.g., type of emergency situation, area covered by the emergency situation, and the like). The geographical area of the “keep out zone” may be manually determined by a representative of the report center 512. The duration of the “keep out zone” may be automatically determined by the report center 512 based on data associated with the emergency situation (e.g., type of emergency situation, area covered by the emergency situation, and the like). The duration of the “keep out zone” may be based on the receipt of data from a fleet vehicle in the area of the “keep out zone” that indicates the end of the emergency situation. In response to the generation of the “keep out zone”, the report center 512 may dispatch a scout vehicle (not shown) to the “keep out zone” to monitor the progress of the emergency situation and notify the report center 512 that the emergency situation has ended. The scout vehicle may be an autonomous vehicle. The report center 512 notifying the fleet vehicles of the “keep out zone” may enable the fleet vehicles to more efficiently navigate in the area of the emergency situation.

With continued reference to FIG. 5, in some non-limiting embodiments or aspects, the vehicle 501 may comprise an autonomous driving system 514. For example, the autonomous driving system 514 may comprise a processor, programming instructions and drivetrain components that are controllable by the processor without requiring a human operator, such that the vehicle 501 is autonomous or semi-autonomous. In some non-limiting examples, the autonomous driving system 514 may be integrated into the ESM 502, such as using some of the same processors, sensors, or other components of the ESM 502. Alternatively, the autonomous driving system 514 may be independent from the ESM 502, having separate processors, sensors, or other components. In some non-limiting embodiments or aspects the autonomous driving system 514 may be partially integrated into the ESM, such that certain processors, sensors, or other components are shared while others are separate.

In some non-limiting embodiments or aspects, in response to the ESM 502 identifying an emergency situation, the communication processor 510 may communicate at least a portion of the environment data from the data packet to the autonomous driving system 514 to cause the autonomous driving system 514 to automatically execute at least one avoidance action. For example, the autonomous driving system 514 may analyze the environment data from the data packet to determine that an avoidance action is required to avoid a collision or other undesirable interaction with the emergency situation. The avoidance action may comprise an acceleration, a deceleration, a brake, a directional change, or the like.

With continued reference to FIG. 5, the ESM 502 may operate in a default mode in which an emergency situation has not been detected by operating a detection task. The detection task may comprise various subtasks that actively check for emergency situations. These subtasks comprise scanning the environment of the vehicle 501 with the sensors 504 to collect environment data and inputting the environment data to the emergency model 506 so that the emergency model 506 can analyze the environment data for a potential emergency situation. In the detection tasks, certain functions associated with capturing certain metadata may be deactivated, as no emergency data packet needs generated in the absence of an emergency situation.

In response to the emergency model 506 detecting and identifying an emergency situation, the ESM 502 may initiate a capture task. The capture task may include recording of the emergency situation with the sensors 504, as opposed to merely scanning the environment with the sensors in the detection task. The recording may include storage of the recorded data from the sensors 504 in at least one database for longer term (e.g., more than transient) storage. The recording subtask may include initiating recording of all sensors 504 of the ESM 502 or only select sensors 504 identified as having the emergency situation potentially within range. The capture task may include the subtask of compiling data and metadata relevant to the emergency situation. This may be completed at every distinct geographic location (e.g., of the vehicle 501). This data and metadata may be the data previously described as being included in the data packet (e.g., data associated with the sensors 504, the vehicle 501, the environment, and the like).

In response to the sensors 504 no longer sensing environment data corresponding to the emergency situation, the capture task may be deactivated. This may terminate further capturing of data and/or metadata associated with the sensors 504 associated with the emergency situation.

During the capture task or after termination of the capture task, the ESM 502 may activate a reporting task. The reporting task may involve the ESM 502 reporting the emergency situation to the report center 512. The reporting task may comprise the subtask of generating the data packet using the packet generator 508. This may include formatting the data packet as needed, compressing the data packet as needed, or otherwise preparing the data packet for transmission by the communication processor 510 or receipt by the report center 512. The data packet may be generated and transmitted during the capture task. Alternatively, the data packet may be generated in response to the sensors 504 no longer sensing environment data corresponding to the emergency situation such that the capture task has been deactivated. In some non-limiting examples, deactivation of the capture task may initiate generation of the data packet, while in other examples, early generation of the data packet, or at least an initial data packet may be desired such that it is generated during the capture task and transmitted quickly to the report center 512.

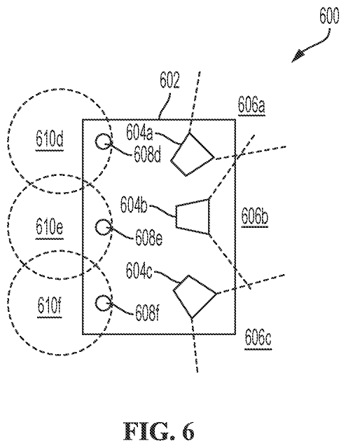

Referring to FIG. 6, an emergency detection system 600 is shown according to some non-limiting embodiments or aspects. The emergency detection system 600 may comprise a vehicle 602 comprising a plurality of visual sensors 604a-c arranged on the vehicle 602 and a plurality of audio sensors 608d-f arranged on the vehicle 602. While the visual sensors 604a-c and audio sensors 608d-f are shown mounted to the top of the vehicle 602, their position is for exemplary purposes only, and they may be arranged on the vehicle 602 in any suitable position or arrangement.

The visual sensors 604a-c may have a range over which they can sense images, such that each visual sensor 604a-c senses within an area 606a-c. The areas 606a-c sensed by the visual sensors 604a-c may partially overlap, while each visual sensor 604a-c may also sense an area partially different from the other visual sensors 604a-c. Therefore, each visual sensor 604a-c may be configured to collect environment data corresponding to a different area 606a-c surrounding the vehicle 602. The visual sensors 604a-c may sense at least one of: the shape of the image in the area 606a-c, the distance of the image from the vehicle 602, a direction of the image and/or the direction in which the image is moving.

The audio sensors 608d-f may have a range over which they can sense sounds, such that each audio sensor 608d-f senses within an area 610d-f. The areas 610d-f sensed by the audio sensors 608d-f may partially overlap, while each visual sensors 608d-f may also sense an area partially different from the other audio sensor 608d-f. Therefore, each audio sensor 608d-f may be configured to collect environment data corresponding to a different area 610d-f surrounding the vehicle 602. The audio sensors 608d-f may sense at least one of: a sound associated with the surroundings 610d-f, the distance of the sound from the vehicle 602, a direction of the sound and/or the direction in which the sound is moving.

With continued reference to FIG. 6, each sensor 604a-c and 608d-f may have a unique sensor identifier identifying it from the other sensors 604a-c and 608d-f. Moreover, each sensor 604a-c and 608d-f may have a unique location identifier identifying its location from the location of other sensors 604a-c and 608d-f; this may include a geolocation location (GPS and/or what 3words) and/or a descriptive location relative to the vehicle 602. The environment data collected by each sensor 604a-c and 608d-f may be associated with the sensor identifier and/or location identifier of the sensor 604a-c and 608d-f which collected the data.

For a particular emergency situation, a plurality of visual sensors 604a-c or a plurality of audio sensors 608d-f may sense the same situation or portion thereof based on an overlap of the areas 606a-c and 610d-f covered by the plurality of visual sensors 604a-c or plurality of audio sensors 608d-f. However, although the same situation or portion thereof may be simultaneously captured by two different visual or audio sensors 604a-c and 608d-f, the image or sound sensed may be sensed at a different distance from the sensors 604a-c and 608d-f or from a different direction relative to the sensors 604a-c and 608d-f. This corresponding data collected by two different sensors 604a-c and 608d-f may be associated with one another to provide comprehensive data about the situation or portion thereof from different perspectives. The sensor identifier and location identifier associated with the corresponding data may provide context in which to better understand the data sensed by the different sensors 604a-c and 608d-f. In this way, the environment data corresponding to the emergency situation and contained in the data packet may comprise first data collected by a first audio and/or visual sensor (e.g., 608d or 604a) and second data collected by a second audio and/or visual sensor (e.g., 608e or 604b), and the first data is associated with a first identifier corresponding to the first audio and/or visual sensor (e.g., 608d or 604a), and the second data is associated with a second identifier corresponding to the second audio and/or visual sensor (e.g., 608e or 604b).

In some non-limiting embodiments or aspects, the vehicle 602 may be moving and/or the emergency situation or portion thereof may be moving such that the emergency situation is sensed by a first audio and/or visual sensor (e.g., 608d or 604a) at a first time and sensed by a second audio and/or visual sensor (e.g., 608e or 604b) at a second time. For example, in FIG. 6, a stationary emergency situation may first be sensed by visual sensor 604a at a front of the vehicle 602 in its sensed area 606a, and as the vehicle 602 moves forward, the emergency situation may later be sensed by visual sensor 604b at a side of the vehicle 602 in its sensed area 606b. This data sensing the same emergency situation but at different times using the two different sensors 604a and 604b may be associated with one another to provide comprehensive data about the situation or portion thereof from different perspectives. The sensor identifier and location identifier associated with the corresponding data may provide context in which to better understand the data sensed by the different sensors 604a-c and 608d-f. In this way, the environment data corresponding to the emergency situation and contained in the data packet may comprise first data collected by a first audio and/or visual sensor (e.g., 608d or 604a) and second data collected by a second audio and/or visual sensor (e.g., 608e or 604b), and the first data is associated with a first identifier corresponding to the first audio and/or visual sensor (e.g., 608d or 604a), and the second data is associated with a second identifier corresponding to the second audio and/or visual sensor (e.g., 608e or 604b).

With continued reference to FIG. 6, in some non-limiting embodiments or aspects, corresponding environment data from different types of sensors (e.g., video and audio sensors) may be associated with one another to provide comprehensive data about the situation or portion thereof from different perspectives. For example, visual sensor 604a may sense visual aspects of the emergency situation contemporaneously with audio sensor 608d sensing audio aspects of the same emergency situation. Since the visual and audio data sense the same emergency situation at the same time, the visual and audio data may be associated with one another to provide comprehensive data about the situation or portion thereof.

In the surroundings of the vehicle 602, two (or more) different types of emergency situations may be occurring at overlapping times or the emergency situation occurring may have a plurality of different subtypes which define the situation. For example, a first audio and/or visual sensor (e.g., 608d or 604a) may sense a first type or subtype of emergency situation, and a second audio and/or visual sensor (e.g., 608e or 604b) (or again the first audio and/or visual sensor (e.g., 608d or 604a)) may contemporaneously sense a second type or subtype of emergency situation. The ESM may generate a single data packet or separate data packets to report the different types of emergency situations occurring simultaneously together or separately.

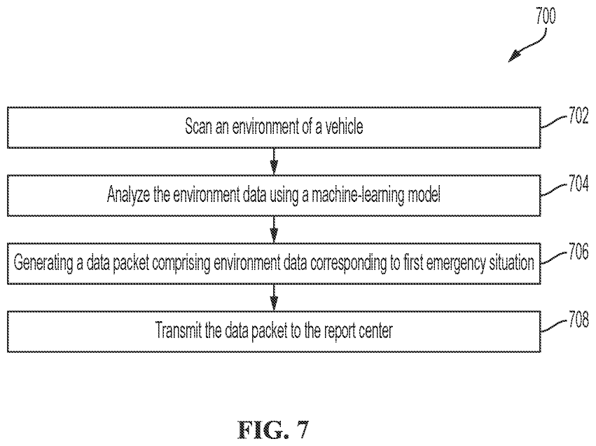

Referring to FIG. 7, a computer-implemented method 700 for automatically detecting an emergency situation is shown according to non-limiting embodiments or aspects. At a step 702, at least one sensor (e.g., the sensor 504 of FIG. 5) of the ESM may scan an environment of a vehicle on which the at least sensor is connected to collect environment data. At a step 704, a machine learning model (e.g., the emergency model 506 of FIG. 5) may analyze the environment data. The machine learning model may have been trained using historical data to recognize a plurality of emergency situations. Analyzing the environment data may comprise identifying at least a portion of the environment data as corresponding to a first emergency situation of a plurality of emergency situations. At a step 706, in response to identifying the first emergency situation, a processor (e.g., the packet generator 508 of FIG. 5) may generate a data packet comprising the environment data corresponding to the first emergency situation. At a step 708, at least one processor (e.g., the communication processor 510 of FIG. 5) may transmit the data packet to a report center to report the first emergency situation.

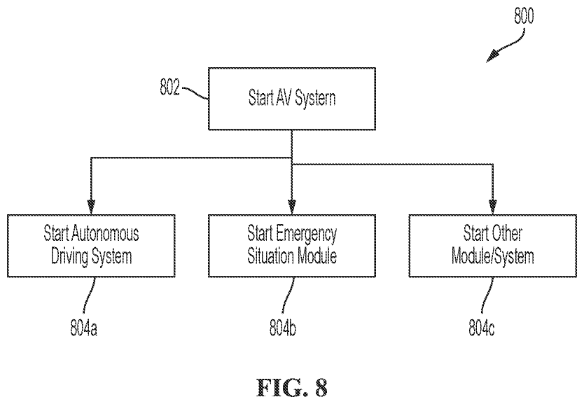

Referring to FIG. 8, a method 800 is shown for starting an autonomous vehicle system according to non-limiting embodiments or aspects. At a step 802, an autonomous vehicle system may be started which enables control of various aspects of an autonomous vehicle (e.g., vehicle 501 of FIG. 5). For example, the autonomous vehicle system may be started by starting the vehicle itself (e.g., initiating ignition of the vehicle). At a step 804a, starting of the autonomous vehicle system may cause starting of the autonomous vehicle driving system (e.g., the autonomous driving system 514 of FIG. 5), which enables autonomous control of the movement of the vehicle, such as steering, accelerating, decelerating, and braking. At a step 804b, starting of the autonomous vehicle system may cause starting of the ESM (e.g., the ESM 502 of FIG. 5), which enables the automatic detection of an emergency situation as described herein. At a step 804c, starting of the autonomous vehicle system may cause starting of other modules/systems used to operate the autonomous vehicle.

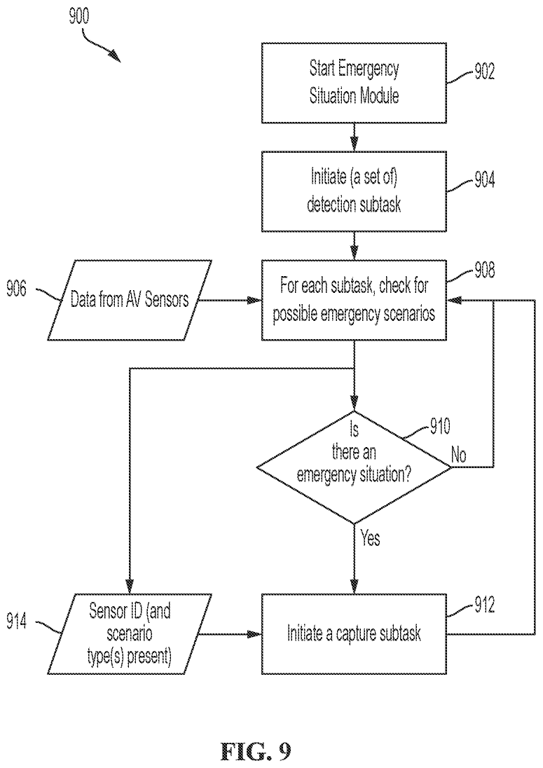

Referring to FIG. 5 and FIG. 9, a method 900 is shown for executing the detecting and capture tasks of the ESM 502 according to non-limiting embodiments or aspects. At a step 902, the ESM 502 may be initiated. At a step 904, the ESM 502 may initiate the detecting task as described herein, including the subtasks thereof as described herein. As part of the detecting task, at a step 906, environment data from the sensors 504 may be input to the emergency model 506. At a step 908, the emergency model 506 may analyze the input environment data to check for a possible emergency situation. At a decision 910, the emergency model 506 determines whether an emergency situation is present based on the input environment data. If no emergency situation is detected, the emergency model 506 may continue to receive environment data from the sensors 504 and analyze the newly received environment data for an emergency situation.

If the emergency model 506 detects and identifies an emergency situation, at a step 912, the ESM 502 may initiate the capture task as described herein, including the subtasks thereof as described herein. The initiated capture task may include, at a step 914, capturing relevant data and/or metadata corresponding to the emergency situation, including sensor identifiers, audio and/or visual data, vehicle data, and the like.

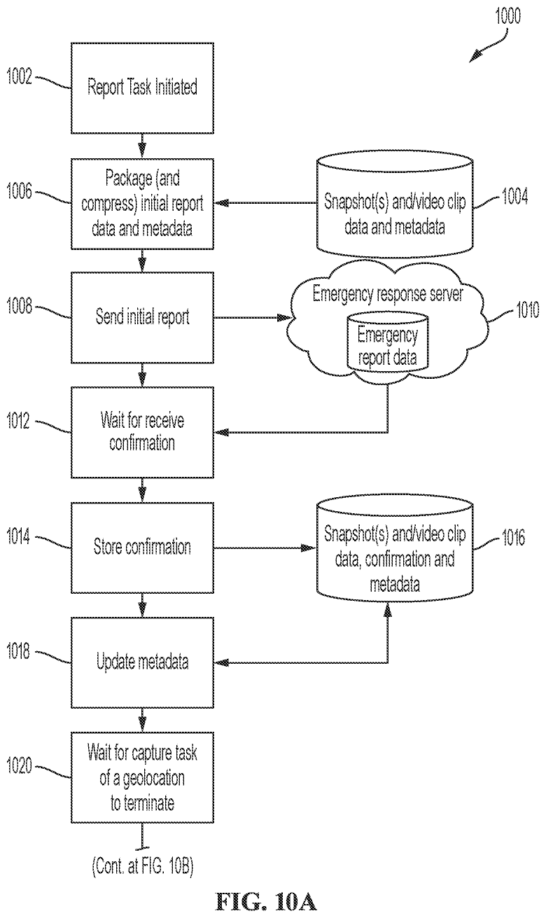

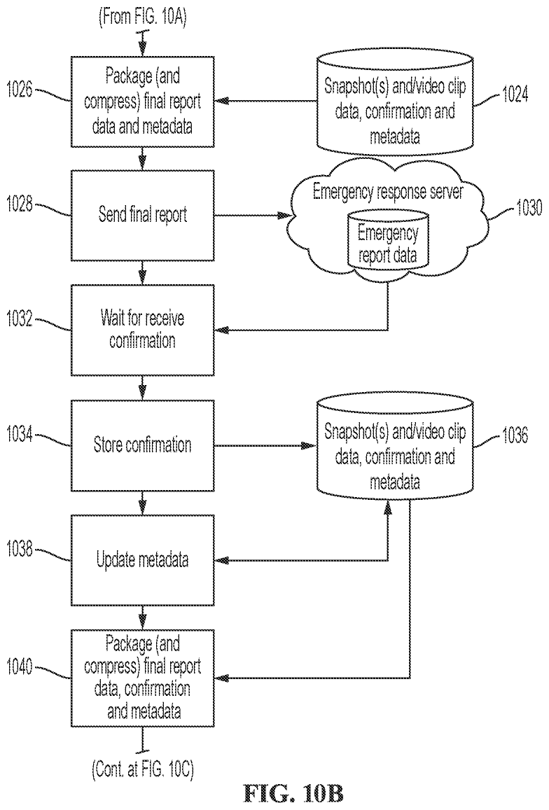

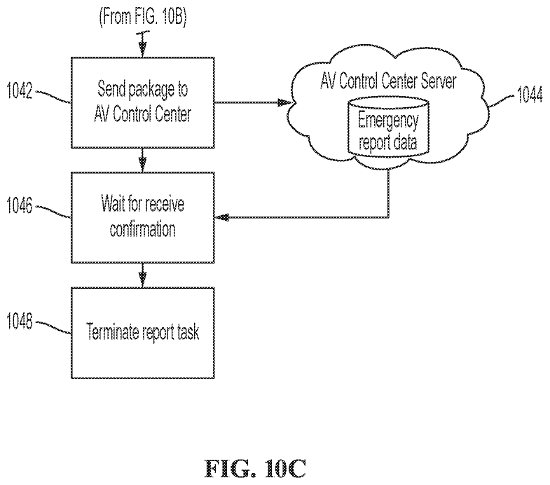

Referring to FIGS. 10a-10c, a method 1000 is shown for automatically detecting an emergency situation using a direct reporting task according to non-limiting embodiments or aspects. At a step 1002, the reporting task as described herein may be initiated. At a step 1004, captured data and metadata associated therewith associated with an emergency situation may be received (e.g., by the packet generator 508 of FIG. 5). At a step 1006, the packet generator may generate a data packet containing relevant data/metadata corresponding to the emergency situation. The data packet may comprise compressed or uncompressed data. This data packet may constitute an initial report as the emergency situation may be ongoing such that further capture tasks are being conducted; nonetheless, the initial data packet may be generated and transmitted to notify the report center (e.g., the emergency response server) of the emergency situation immediately. At a step 1008 the initial data packet may be sent (e.g., by the communication processor 510 of FIG. 5) to an emergency response server (e.g., the report center 512 of FIG. 5). In this direct reporting situation, the emergency response server may be a processor operated by or on behalf of a first responder system, such that the data packet may be transmitted directly to first responders equipped to respond to the emergency situation. At a step 1010, the emergency response server may store the data packet in an emergency report data database, and the emergency response server may also initiate a response to the emergency situation. At a step 1012, the emergency response server may return a confirmation receipt upon receiving the initial data packet, and at a step 1014, the confirmation receipt may be stored, and at a step 1016, that confirmation receipt may be stored in association with captured data and metadata previously captured. At a step 1018, the relevant metadata may be updated.

With continued reference to FIG. 10a-10c, at a step 1020 the system may wait for the capture task for a particular geolocation to terminate. At a step 1024, captured data and metadata associated therewith captured after the initial data packet and associated with a particular geolocation may be communicated to the packet generator. At a step 1026, the packet generator may generate a data packet for that geolocation containing relevant data/metadata corresponding to the emergency situation. This data packet may constitute the updated and/or final report about the emergency situation, such that the initial data packet and any updated and/or final data packet provide the full report corresponding to the emergency situation. At a step 1028, the final data packet may be transmitted to the emergency response server. At a step 1030, the emergency response server may store the final data packet in the emergency report data database, and this final data packet may be stored in association with the initial data packet. This final data packet may cause the emergency response server to initiate a response or further response to the emergency situation. At a step 1032, the emergency response server may return a confirmation receipt upon receiving the final data packet, and at a step 1034, the confirmation receipt may be stored, and at a step 1036, that confirmation receipt may be stored in association with captured data and metadata previously captured. At a step 1038, the relevant metadata may be updated.

With continued reference to FIG. 10a-10c, at a step 1040, the system may package and compress the initial and/or final data packet, the confirmation, and the updated metadata into a package. At a step 1042, the package may be transmitted to an autonomous vehicle control center server, which may serve as a control center for the vehicle. At a step 1044, the autonomous vehicle control center server may store the package in an emergency report data database of the vehicle. At a step 1046, the autonomous vehicle control center server may return a confirmation receipt upon receiving the package. At a step 1048, the reporting task may be terminated by the ESM.

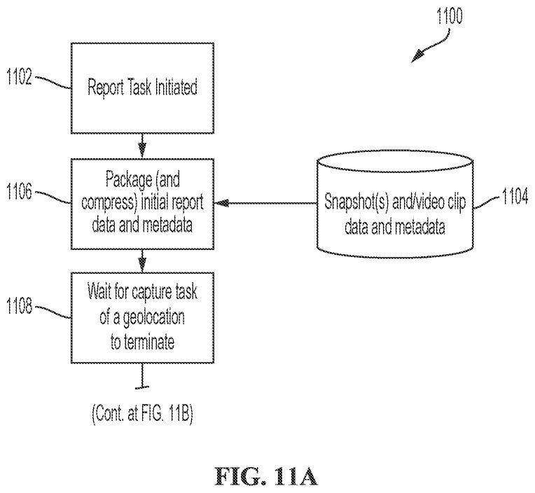

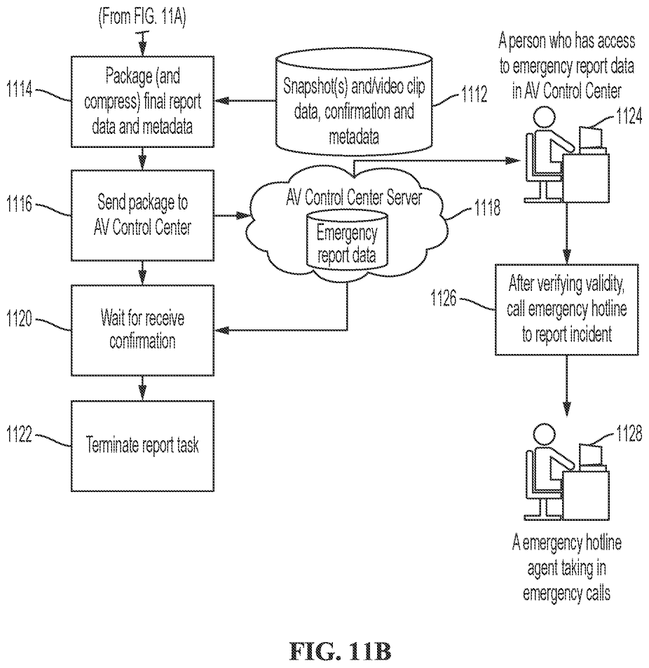

Referring to FIGS. 11a-11b, a method 1100 is shown for automatically detecting an emergency situation using an indirect reporting task according to non-limiting embodiments or aspects. At a step 1102, the reporting task as described herein may be initiated. At a step 1104, captured data and metadata associated therewith corresponding to an emergency situation may be received (e.g., by the packet generator 508 of FIG. 5). At a step 1106, the packet generator may generate a data packet containing relevant data/metadata corresponding to the emergency situation. The data packet may comprise compressed or uncompressed data. This data packet may constitute an initial report as the emergency situation may be ongoing such that further capture tasks are being conducted; nonetheless, the initial data packet may be generated. This initial data packet may not be immediately transmitted to an emergency response server as in the method 1000 from FIG. 10.

With continued reference to FIGS. 11a-11b, at a step 1108, the system may wait for the capture task for a particular geolocation to terminate. At a step 1112, captured data and metadata associated therewith captured after the initial data packet and associated with a particular geolocation may be communicated to the packet generator. At a step 1114, the packet generator may generate a data packet for that geolocation containing relevant data/metadata corresponding to the emergency situation. This final data packet may include the data from the initial data packet and any relevant updated data, and this final data packet may constitute the final report about the emergency situation.

At a step 1116, the final data packet may be transmitted to an autonomous vehicle control center server, which may be a control center communicating with a plurality of vehicles, and to which this plurality of vehicles may report emergency situations. The autonomous vehicle control center server may be different from the emergency response server from the method 1000 of FIG. 10, as the emergency response server is operated by or on behalf of a first responder system, while the autonomous vehicle control center server is an intermediary system separate from the first responder system. In this way, the method 1100 described in FIG. 11 is an indirect reporting method. At a step 1118, the autonomous vehicle control center server may store the final data packet in an emergency report data database. At a step 1120, the autonomous vehicle control center server may return a confirmation receipt upon receiving the final data packet. At a step 1122, the reporting task may be terminated by the ESM.

With continued reference to FIGS. 11a-11b, at a step 1124, the autonomous vehicle control center server may verify that the final data packet corresponds to an emergency situation, to confirm the emergency model's identification of the situation as an emergency situation. This verification may be automatically performed by at least one processor of the autonomous vehicle control center server, or a representative associated with the autonomous vehicle control center server may verify the emergency situation. At a step 1126, after verifying the validity of the emergency situation, the autonomous vehicle control center server may notify an emergency response server operated by or on behalf of a first responder system. To notify the emergency response server, the autonomous vehicle control center server may transmit at least a portion of the final data packet to the emergency response server. Additionally or alternatively, a representative associated with the autonomous vehicle control center server may contact a representative of the emergency response server. At a step 1128, the emergency response server may initiate a response action to the emergency situation.

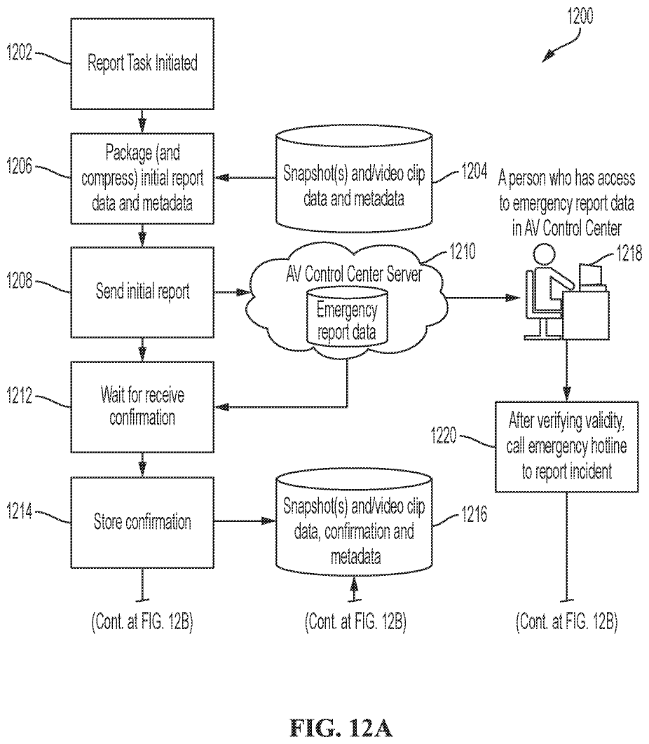

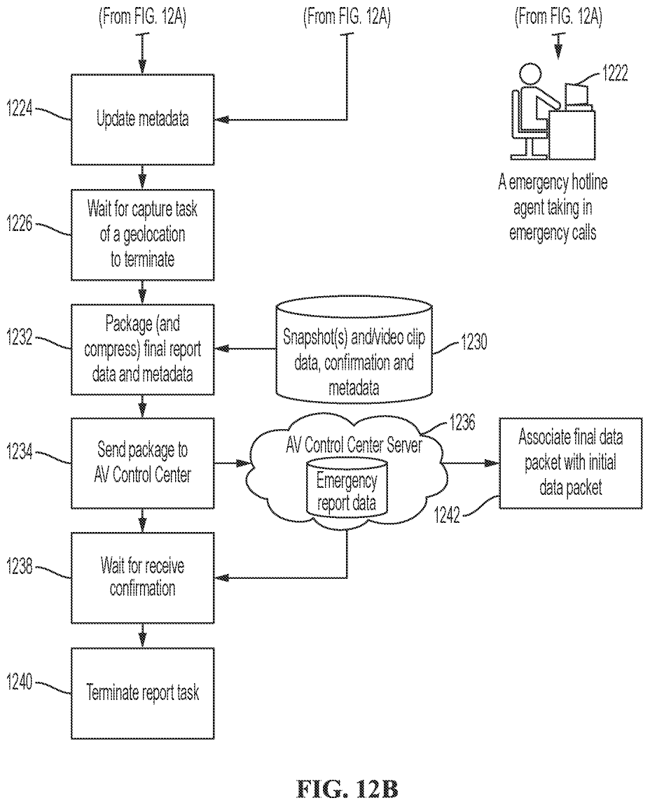

Referring to FIGS. 12a-12b, a method 1200 is shown for automatically detecting an emergency situation using an indirect reporting task according to non-limiting embodiments or aspects. At a step 1202, the reporting task as described herein may be initiated. At a step 1204, captured data and metadata associated therewith associated with an emergency situation may be received (e.g., by the packet generator 508 of FIG. 5). At a step 1206, the packet generator may generate a data packet containing relevant data/metadata corresponding to the emergency situation. The data packet may comprise compressed or uncompressed data. This data packet may constitute an initial report as the emergency situation may be ongoing such that further capture tasks are being conducted; nonetheless, the initial data packet may be generated and transmitted to notify the report center (autonomous vehicle control center server and/or emergency response server) of the emergency situation immediately. At a step 1208 the initial data packet may be sent (e.g., by the communication processor 510 of FIG. 5) to an autonomous vehicle control center server (e.g., the report center 512 of FIG. 5). The autonomous vehicle control center server may be different from the emergency response server from the method 1000 of FIG. 10, as the emergency response server is operated by or on behalf of a first responder system, while the autonomous vehicle control center server is an intermediary system separate from the first responder system. The autonomous vehicle control center server may be a control center communicating with a plurality of vehicles, and to which this plurality of vehicles may report emergency situations. In this way, the method 1200 described in FIG. 12 is an indirect reporting method. At a step 1210, the autonomous vehicle control center server may store the initial data packet in an emergency report data database. At a step 1212, the autonomous vehicle control center server may return a confirmation receipt upon receiving the initial data packet. At a step 1214, the confirmation receipt may be stored, and at a step 1216, that confirmation receipt may be stored in association with captured data and metadata previously captured.

At a step 1218, the autonomous vehicle control center server may verify that the initial data packet corresponds to an emergency situation, to confirm the emergency model's identification of the situation as an emergency situation. This verification may be automatically performed by at least one processor of the autonomous vehicle control center server, or a representative associated with the autonomous vehicle control center server may verify the emergency situation. At a step 1220, after verifying the validity of the emergency situation, the autonomous vehicle control center server may notify an emergency response server operated by or on behalf of a first responder system. To notify the emergency response server, the autonomous vehicle control center server may transmit at least a portion of the initial data packet to the emergency response server. Additionally or alternatively, a representative associated with the autonomous vehicle control center server may contact a representative of the emergency response server. At a step 1222, the emergency response server may initiate a response action to the emergency situation.

With continued reference to FIGS. 12a-12b, at a step 1224, the relevant metadata may be updated. At a step 1226, the system may wait for the capture task for a particular geolocation to terminate. At a step 1230, captured data and metadata associated therewith captured after the initial data packet and associated with a particular geolocation may be communicated to the packet generator. At a step 1232, the packet generator may generate a data packet for that geolocation containing relevant data/metadata corresponding to the emergency situation. This data packet may constitute the updated and/or final report about the emergency situation, such that the initial data packet and any updated and/or final data packet provide the full report corresponding to the emergency situation.

At a step 1234, the final data packet may be transmitted to the autonomous vehicle control center server (same server as in step 1208). At a step 1236, the autonomous vehicle control center server may store the final data packet in the emergency report data database. At a step 1238, the autonomous vehicle control central server may return a confirmation receipt upon receiving the final data packet. At a step 1240, the reporting task may be terminated by the ESM. At a step 1242, the autonomous vehicle control center server may associate the initial data packet with the final data packet to form a package which provides comprehensive data about the emergency situation. This association of the initial data packet and final data packet may be based on a common unique identifier being included in both. The association may be automatically performed by at least one processor of the autonomous vehicle control center server, or a representative associated with the autonomous vehicle control center server may perform the association.

Various embodiments can be implemented, for example, using one or more computer systems, such as computer system 1500 shown in FIG. 15. Computer system 1500 can be any computer capable of performing the functions described herein.

Computer system 1500 can be any well-known computer capable of performing the functions described herein.

Computer system 1500 includes one or more processors (also called central processing units, or CPUs), such as a processor 1504. Processor 1504 is connected to a communication infrastructure or bus 1506.

One or more processors 1504 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1500 also includes user input/output device(s) 1503, such as monitors, keyboards, pointing devices, etc., that communicate with communication infrastructure 1506 through user input/output interface(s) 1502.

Computer system 1500 also includes a main or primary memory 1508, such as random access memory (RAM). Main memory 1508 may include one or more levels of cache. Main memory 1508 has stored therein control logic (i.e., computer software) and/or data.

Computer system 1500 may also include one or more secondary storage devices or memory 1510. Secondary memory 1510 may include, for example, a hard disk drive 1512 and/or a removable storage device or drive 1514. Removable storage drive 1514 may be a floppy disk drive, a magnetic tape drive, a compact disk drive, an optical storage device, tape backup device, and/or any other storage device/drive.

Removable storage drive 1514 may interact with a removable storage unit 1518. Removable storage unit 1518 includes a computer usable or readable storage device having stored thereon computer software (control logic) and/or data. Removable storage unit 1518 may be a floppy disk, magnetic tape, compact disk, DVD, optical storage disk, and/any other computer data storage device. Removable storage drive 1514 reads from and/or writes to removable storage unit 1518 in a well-known manner.

According to an exemplary embodiment, secondary memory 1510 may include other means, instrumentalities or other approaches for allowing computer programs and/or other instructions and/or data to be accessed by computer system 1500. Such means, instrumentalities or other approaches may include, for example, a removable storage unit 1522 and an interface 1520. Examples of the removable storage unit 1522 and the interface 1520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1500 may further include a communication or network interface 1524. Communication interface 1524 enables computer system 1500 to communicate and interact with any combination of remote devices, remote networks, remote entities, etc. (individually and collectively referenced by reference number 1528). For example, communication interface 1524 may allow computer system 1500 to communicate with remote devices 1528 over communications path 1526, which may be wired and/or wireless, and which may include any combination of LANs, WANs, the Internet, etc. Control logic and/or data may be transmitted to and from computer system 1500 via communication path 1526.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 1500, main memory 1508, secondary memory 1510, and removable storage units 1518 and 1522, as well as tangible articles of manufacture embodying any combination of the foregoing. Such control logic, when executed by one or more data processing devices (such as computer system 1500), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 15. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method comprising:
scanning, with at least one sensor, an environment of an autonomous vehicle on which the at least one sensor is connected to collect environment data;
analyzing, with at least one processor, the environment data using a machine learning model, wherein the machine learning model has been trained using historical data to recognize a plurality of emergency situations, wherein the analyzing comprises identifying at least a portion of the environment data as corresponding to a first emergency situation of a plurality of emergency situations;
in response to identifying the first emergency situation, generating a data packet comprising the environment data corresponding to the first emergency situation; and
transmitting the data packet to a report center to report the first emergency situation.

2. The computer-implemented method of claim 1, wherein the at least one sensor is integrated into an autonomous driving system of the vehicle or is independent from the autonomous driving system.

3. The computer-implemented method of claim 1, further comprising:
in response to identifying the first emergency situation, causing the autonomous vehicle to automatically execute at least one avoidance action.

4. The computer-implemented method of claim 1, wherein the identifying the at least a portion of the environment data as corresponding to a first emergency situation comprises:
identifying a pattern of sounds and/or images in the environment data; and
matching the pattern to a pattern known to the machine learning model as corresponding to the first emergency situation.

5. The computer-implemented method of claim 1, wherein the data packet is transmitted directly to a secure digitized message system of the report center.

6. The computer-implemented method of claim 1, wherein the at least one sensor comprises a plurality of audio and/or visual sensors, each audio and/or visual sensor configured to collect environment data corresponding to a different area surrounding the vehicle.

7. The computer-implemented method of claim 6, wherein the environment data corresponding to the first emergency situation comprises first data collected by a first audio and/or visual sensor of the plurality of audio and/or visual sensors and second data collected by a second audio and/or visual sensor of the plurality of audio and/or visual sensors.

8. The computer-implemented method of claim 7, wherein the data packet comprises the first data associated with a first identifier corresponding to the first audio and/or visual sensor and the second data associated with a second identifier corresponding to the second audio and/or visual sensor.

9. The computer-implemented method of claim 1, wherein the data packet comprises an audio and/or visual clip.

10. The computer-implemented method of claim 1, wherein the data packet comprises at least one of: a data and/or metadata identifier, location data, temporal data, an audio and/or visual sensor identifier, a vehicle identifier, vehicle travel data, audio and/or visual data, or situation identifier data.

11. The computer-implemented method of claim 1, further comprising:
in response to identifying the first emergency situation, activating a capture task to capture data associated with the at least one sensor.

12. The computer-implemented method of claim 11, further comprising: in response to the at least one sensor no longer sensing environment data corresponding to the first emergency situation, deactivating the capture task to terminate capturing metadata associated with the at least one sensor.

13. The computer-implemented method of claim 1, wherein the data packet is generated in response to the at least one sensor no longer sensing environment data corresponding to the first emergency situation.

14. The computer-implemented method of claim 1, wherein the at least one sensor comprises a temperature sensor, pressure sensor, force sensor, vibration sensor, piezo sensor, fluid sensor, gas sensor, humidity sensor, and/or light sensor.

15. A computer program product for reporting an emergency situation, the computer program product comprising at least one non-transitory computer-readable medium comprising one or more instructions that, when executed by at least one processor, cause the at least one processor to:
receive environment data collected by at least one scanning an environment of an autonomous vehicle on which the at least one sensor is connected;
analyze the environment data using a machine learning model, wherein the machine learning model has been trained using historical data to recognize a plurality of emergency situations, wherein the analyzing comprises identifying at least a portion of the environment data as corresponding to a first emergency situation of a plurality of emergency situations;
in response to identifying the first emergency situation, generate a data packet comprising the environment data corresponding to the first emergency situation; and
transmit the data packet to a report center to report the first emergency situation.

16. The computer program product of claim 15, wherein the at least one sensor comprises an audio and/or visual sensor.

17. A system, comprising:
at least one sensor configured to be connected on an autonomous vehicle and configured to scan an environment of the vehicle to collect environment data; and
at least one processor programmed or configured to:
receive the environment data collected by the at least scanning the environment of the vehicle;
analyze the environment data using a machine learning model, wherein the machine learning model has been trained using historical data to recognize a plurality of emergency situations, wherein the analyzing comprises identifying at least a portion of the environment data as corresponding to a first emergency situation of a plurality of emergency situations;
in response to identifying the first emergency situation, generate a data packet comprising the environment data corresponding to the first emergency situation; and
transmit the data packet to a report center to report the first emergency situation.

18. The system of claim 17, wherein the at least one sensor comprises a plurality of audio and/or visual sensors, each audio and/or visual sensor configured to collect environment data corresponding to a different area surrounding the vehicle.

19. The system of claim 18, wherein the environment data corresponding to the first emergency situation comprises first data collected by a first audio and/or visual sensor of the plurality of audio and/or visual sensors and second data collected by a second audio and/or visual sensor of the plurality of audio and/or visual sensors.

20. The system of claim 17, wherein the at least one sensor comprises a temperature sensor, pressure sensor, force sensor, vibration sensor, piezo sensor, fluid sensor, gas sensor, humidity sensor, and/or light sensor.
